(19) United States
(12) Patent Application Publication
(10) Pub. No.: US 2010/0101123 A1
(43) Pub. Date: Apr. 29, 2010

(54) Plateguard

(76) Inventor: Jesus Pacleb, La Jolla, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 12/643,894

(22) Filed: Dec. 21, 2009

Related U.S. Application Data
(63) Continuation-in-part of application No. 11/835,181, filed on Aug. 7, 2007.
(60) Provisional application No. 60/822,189, filed on Aug. 11, 2006.

(51) Int. Cl. G09F 7/18; G09F 7/00; B60R 13/10

(52) U.S. Cl. 40/209

(57) ABSTRACT

A license plate holder for automobiles which allows the maximum viewable area for the plate and offers weather protection. This invention avoids the problem of the license plate frame, tabs and mounting holes covering portions of the plate. The plate is held firmly in the cover even when the plate thickness varies and the cover attaches to the automobile at the back side.

### RELATED APPLICATIONS

This application is a continuation-in-part of U.S. application Ser. No. 11/835,181 filed Aug. 7, 2007.

### FIELD OF THE INVENTION

The present invention relates, in general, to a license plate holder and method for using the same. More particularly, the present invention relates to a license plate holder for automobiles which allows the maximum viewable area for the plate, offers weather protection, and a firm hold on all widths of plates. This invention avoids the problem of the license plate frame or tabs covering portions of the plate. The plate is held firmly in the cover even when the plate thickness varies and the cover attaches to the automobile at the back end.

### BACKGROUND OF THE INVENTION

There are many license plate cover designs used to hold license plates to cars. The license plate holders currently in existence require a thicker outer frame, clamps or mounting holes on the front of the license plate which block a portion of the face of the license plate. They will not firmly hold plates which are not embossed and have a flat surface. The current plate holders usually only are manufactured with a frontal piece and no back portion. The current license plate holders which give the best view of the plate still have components which block the plate view, have no protection for the plate, do not hold the license plate securely in the frame and are often those which cannot be very securely fastened to the car or are flimsy in nature. These plate holders do not have protection for the license plate from the weather or scratches from other objects.

There is, thus, a need for a license plate holder which gives the license plate protection, firmly holds license plates of all widths, allows a full view of the license plate front and can be securely fastened to the automobile.

### SUMMARY OF THE INVENTION

Accordingly, an aspect of the invention involves a method for use and manufacture of a license plate holder which provides license plate protection, firmly holds license plates of all widths, and which provides the maximum viewable area for the license plate with the ability to be securely attached to an automobile. The method includes providing a plate holder manufactured of various materials, with a clear cover to protect the license plate wherein the license plate can be slid into the holder, held firmly in place, and securely fastened to the car and allows a maximized viewable area of the license plate. In one embodiment the plate is slid through the top of the plateguard, while in another embodiment the plate is slid in through the side of the plateguard. The plateguard is securely fastened to the automobile via screws which thread through the front of the plateguard into the license plate and through the back side of the plateguard to connect to the automobile. A clear protecting shield is placed on top of the plateguard over the license plate to protect it. This protecting shield sits inside the inner circumference of the front frame and is held in place by screws. The plateguard has lifters which securely hold the license plate in the plateguard. This plateguard can be manufactured in various embodiments which will be referred to as embodiments in the remainder of this specification. The frontal face of the plateguard can be manufactured in multiple different three dimensional finishes which is displayed in the figures and described in more detail below.

### BRIEF DESCRIPTION OF THE DRAWINGS

The accompanying drawings, which are incorporated in and constitute a part of the specification, illustrate embodiments of the invention and, together with the description, serve to explain the objects, advantages, and principles of the invention. In the drawings,

FIG. 1 is a perspective front view of an embodiment of the plateguard;

FIG. 2 is a front view of an embodiment of the plateguard with a protectant shield;

FIG. 3 is a rear view of an embodiment of the plateguard.

FIG. 4 is a side view of the top of an embodiment of the plateguard;

FIG. 5 is a side view of the side of an embodiment of the plateguard;

FIG. 6 is a perspective rear view of a second embodiment of the plateguard;

FIG. 7 is a side cross section view of a second embodiment of the plateguard;

FIG. 8 is a perspective frontal view of a second embodiment of the plateguard with a protectant shield;

FIG. 9 is a perspective rear view of a third embodiment of the plateguard;

FIG. 10 is a side cross section view of a third embodiment of the plateguard;

FIG. 11 is a perspective frontal view of a third embodiment of the plateguard with a protectant shield;

FIG. 12 is a front perspective view of the clear protecting shield which fits into the plateguard;

FIG. 13 is a cross sectional view of the top of the clear protecting shield of the license plate holder;

FIG. 14 is a cross sectional view of the clear protecting shield of the license plate holder;

FIG. 15 is a side cross sectional view of the side of the clear protecting shield showing the screw hole;

FIG. 16 is a side cross sectional view of the side of the first embodiment of the license plate holder;

FIG. 17 is a side cross sectional view of the top of the first embodiment of the license plate holder;

FIG. 18 is a cross-sectional side view of the top frame of one embodiment of the plateguard;

FIG. 19 is a cross-sectional side view of the frame of an embodiment of the plateguard;

FIG. 20 is a cross-sectional side view of the top frame of an embodiment of the plateguard;

FIG. 21 is a cross-sectional side view of the top frame of an embodiment of the plateguard;

FIG. 22 is a cross-sectional side view of the top frame of an embodiment of the plateguard.

### DETAILED DESCRIPTION OF PREFERRED EMBODIMENTS

After reading this description it will become apparent to one skilled in the art how to implement the invention in various alternative embodiments and alternative applications. However, all the various embodiments of the present invention will not be described herein. It is understood that the embodiments presented here are presented by way of an example only, and not limitation. As such, this detailed description of various alternative embodiments should not be construed to limit the scope or breadth of the present invention as set forth below.

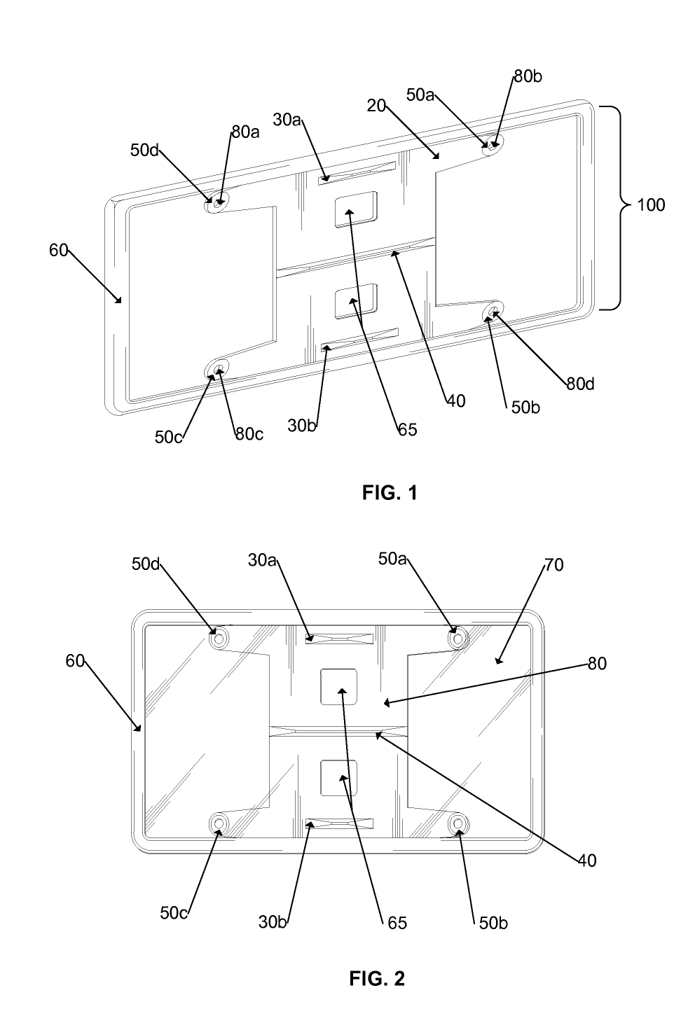

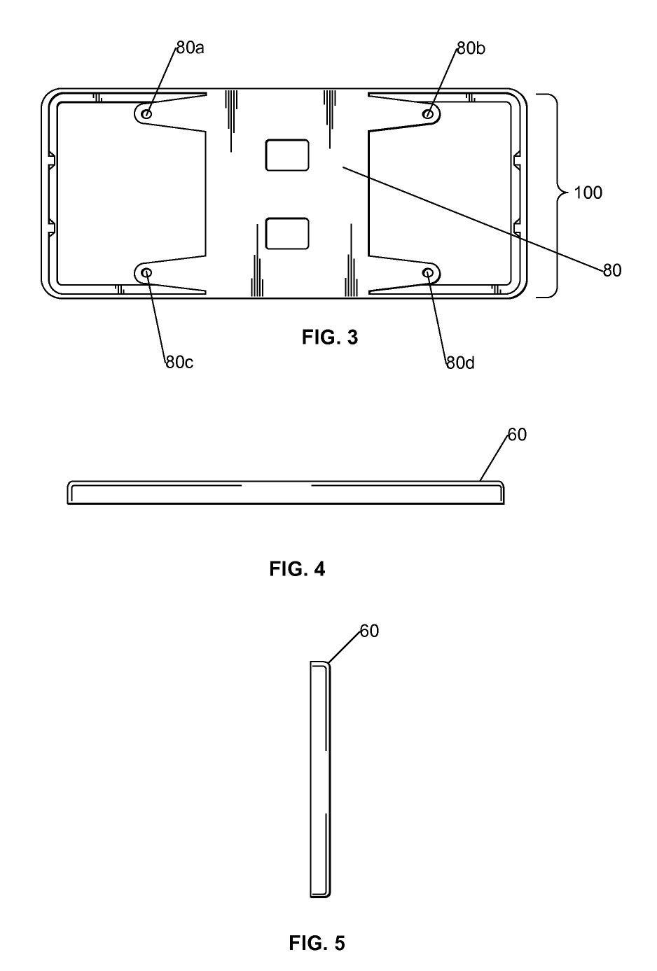

With a reference to FIGS. 1, 2, 3 and 4, a preferred embodiment of the license plate holder the plateguard 100 is shown and displayed. A plateguard 100 is a sturdy unit which holds a license plate securely between its front and back portions and holds the plateguard and license plate to the front or back of an automobile or truck. The plateguard 100 is unique in that it does not have tabs or extensions which cover any portion of the front side of the license plate. The plateguard 100 is very unobtrusive in that it only covers a small surface area of the license plate. The front face 110 of the plateguard only covers ¼ to ½ inch of the circumference of the license plate. License plates in all 50 states have an edge which is either beveled or channeled, and the plateguard 100 covers this portion.

In a preferred embodiment the plateguard has lifters which can be seen at 30a and b, 40 and 50a, b, c and d. These lifters extend from the interior facing section of the back portion of the plateguard. There are horizontal lifters seen at 30a, 30b and 40. In this embodiment there are also lifters at the corner of the “H shape” at 50a, b, c and d. The purpose of these lifters is to press against the back of the license plate and hold it firmly to the outer frame 60 of the plateguard 100. These lifters enable license plates of various widths or embossed versus nonembossed license plates to be slid into the plateguard and held securely and firmly. The lifters hold the plate so securely that there is no vibration in the plate as the car moves. The horizontal lifter at 40 extends the entire width of the H-shaped back portion of this preferred embodiment.

In a preferred embodiment the plateguard 100 can be manufactured so that the back portion and the front portion are all one unit. This plateguard 100 allows the license plate to be slid into the frame through the top or bottom or in alternate embodiments the right and left. In the embodiment at FIGS. 1, 2, 3 and 4 the license plate is slid through the side. The back side 80 of the plateguard 100 can be bent at either side of the H shape to allow the license plate to be slid into place and the frame will retract back into shape. In FIG. 1 the back 80 has an H shape. In this embodiment, the back side 80 of the plateguard 100 is attached to the front rim 60 of the plateguard at the top and bottom sides. The length of the connection piece of the front and back approximately ranges from 1/12 to ¼ the entire length of the side of the plateguard. This configuration allows either side of the back side 20 to be easily flexed for insertion of the license plate.

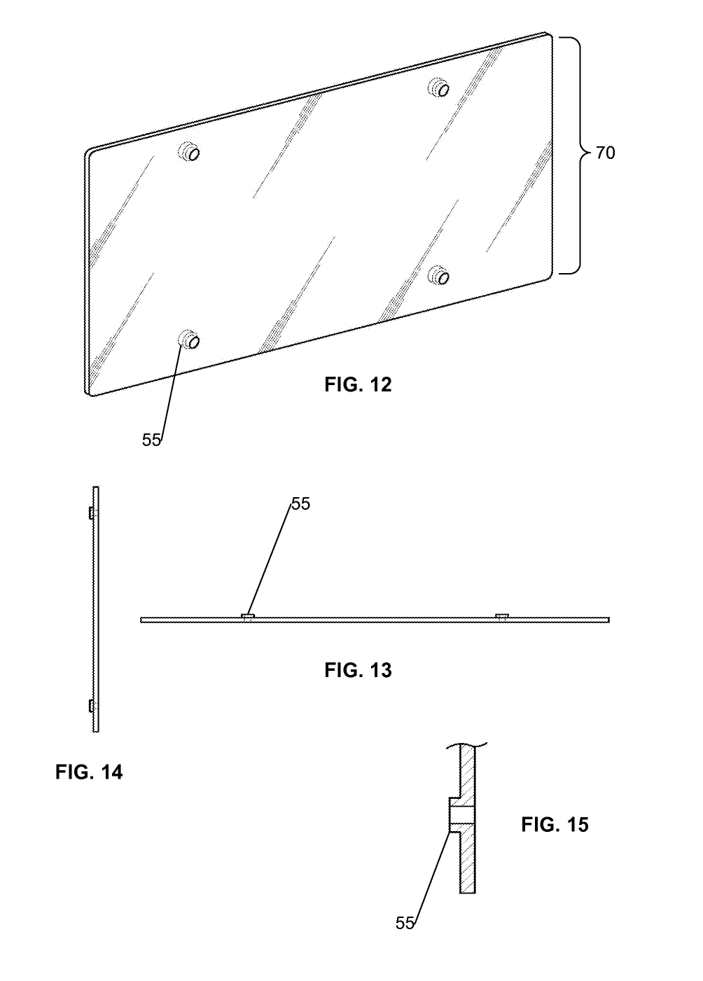

This preferred embodiment of the plateguard can also have a clear protecting shield 70. The clear protecting shield 70 is placed on top of the plateguard and sits inside the inner circumference of the front 60 front portion. The license plat can be clearly seen through the protecting shield 70 as it is transparent. The clear protecting shield covers the front side of the license plate and is secured by the screws which pass through the clear protecting shield 70 through the license plate and the plateguard 100. This protecting shield 70 as seen on at FIG. 2 protects the license plate from scratches, dents and abrasions. This protecting shield further protects the license plate from the weather, erosion from salt and potential UV rays. Additionally, this protecting shield 70 covers a license plate so that the attached registration stickers cannot be removed by a passer by. The screws which attach the plateguard 100 to the license plate and to the automobile pass through the shield 70 and hold it firmly to the car. There are screw holes in the protecting shield to hold it in place see FIG. 12. In order to reach the front face of a license plate, a person would need to unscrew the entire assembly from the car and disassemble the protecting shield 70 from the plateguard 100.

The back portion of the preferred embodiment of the plateguard 100 also has two holes 65 located in the center of the H. These holes 65 allow for the plateguard to be lighter in weight. These holes 65 also have a further benefit in that they reduce the vibration of the license plate and plateguard assembly when the car or truck is in movement.

The plateguard 100 is secured to the car by four or more bolts or screws which are screwed through holes 80a, 80b, 80c and 80d in the plateguard and into the license plate. The back side 80 of the plateguard is mounted directly onto the automobile's license plate space. The same screws hold the license plate in the plateguard and the plateguard to the automobile. This plateguard 100 is rigid and sturdy due to its large portion of surface area on the rear side. Yet it is lightweight as it has a narrow face 60 and a back portion 80 which is H shaped with holes. The plateguard is also pliable and retracts back into shape if it is bent.

This embodiment of the plateguard 100, as well as the remaining embodiments of the plateguard which will be described in more detail below can be manufactured from various substances. A few of the substances which may be used would include Eastman Durastar™ polymer, high impact polymer, ABS natural plateable grade plastic, ABS plastic, high impact polystyrene (HIPS or PS-I), styrene polymers, styrene, high resistant nylon, heat resistant nylon, sheet metal, aluminum, stainless steel, carbon fiber, flexible graphite, polyurethane, wood, flexible fiberglass, ethylene propylene diene monomer (E.P.D.M.), brass, and dye cast zinc and/or a variety of other substances.

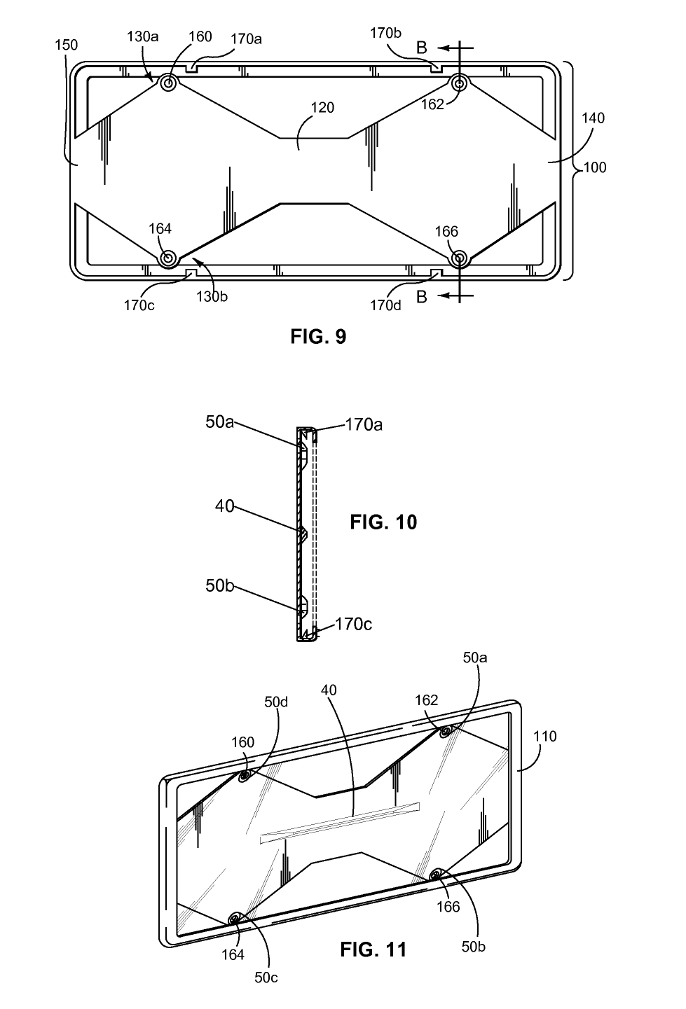

The embodiments displayed in FIGS. 1, 2, 3, 4, 5, 6, 7, 8, 9, 10, and 11 of the license plate are sturdier and stronger than the standard license plate holders because of their insert design nature (having a front and back side) and larger rear surface area securing the front and back of the frame. Due to its slim design the plateguard 100 allows any license plate to slide into the plateguard 100 and does not allow a license plate to get obstructed or stuck due to the fact that it has stickers, slogans or other commemorative statements which cause the license plate to be thicker in diameter. The plateguard 100 disclosed herein meets the legal dimension requirement in all fifty of the United States because it only covers a little over ¼ of an inch of the entire circumference of the license plate face. The configuration of the front face 110 of the plateguard 100 allows the maximum surface area of the license plate to remain unobstructed.

A clear protecting shield 70 for the plateguard is displayed at FIGS. 12, 13, 14, and 15. This shield is manufactured of a clear plastic substance. The shield has screw holes which match up with the plateguard 100 so that the screws can pass through the shield, plateguard and license plate and connect the whole assembly the automobile or truck. The shield is a thin material so that it does not add extensive additional weight to the assembly. However the shield is rigid in that it will not flex, bend or warp when covering the license plate. As can be seen in FIG. 15, the screw hole 72 has a raised outer edge 55. This raised outer edge 55 provides a space for the embossed portion of a license plate. If this space is very important to allow sufficient room for the embossed portion of the license plate to sit.

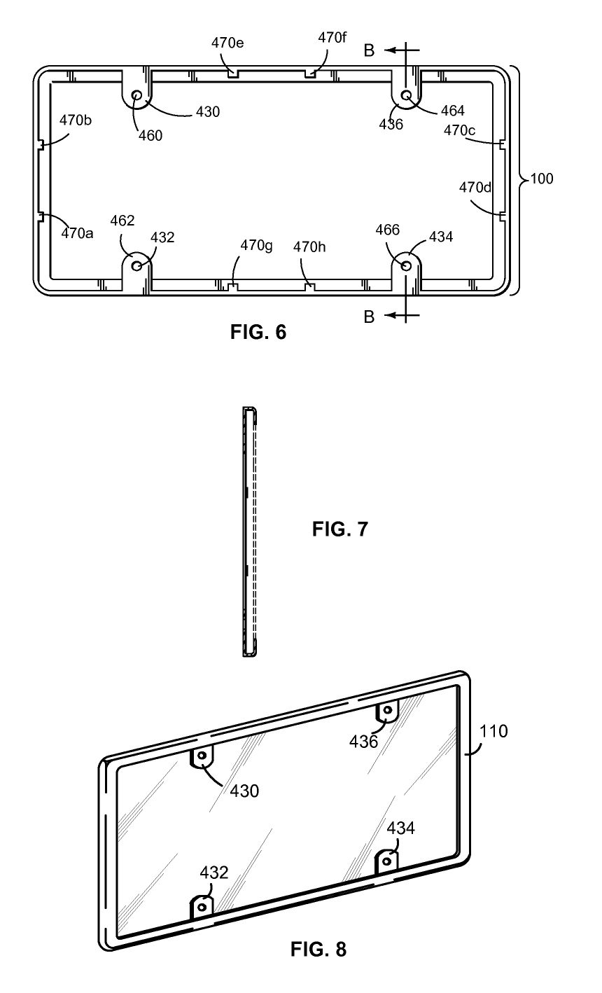

Another embodiment of the plateguard 100 is displayed in FIGS. 6, 7 and 8. This embodiment of the plateguard 100 uses four small rounded extensions 430, 432, 434 and 436 which extend into the interior space of the back side of the plateguard and each contain a small hole 460, 462, 464 and 466. This embodiment of the plateguard is manufactured from metal. The tabs can be bent in when the user pushes on them to hold the license plate in place. In embodiments which are manufactured from a plastic type substance the tabs are formed in a triangle configuration. A screw threads through the small hole in each of the extensions to secure the plateguard to the car. The license plate can be placed into this embodiment. In this embodiment, once the license and plate placed into the plateguard it is held firmly in place by folding the tabs 470(a), (b), (c), (d), (e), (f), (g) and (h) which are located on the back side of the plateguard. This embodiment of the plateguard allows a large portion of the plate to be seen on the front side. One half an inch or less of an inch of the circumference of the license plate is covered once it is inserted into this plateguard.

The third preferred embodiment of the plateguard 100 is displayed in FIGS. 9, 10 and 11. In the third embodiment the license plate is inserted into the plateguard via the top 130a or bottom side 130b. The backside 120 of the plateguard is attached to the sides of the front 110 of the plateguard. The length of the connection piece of the front 110 and back 140 ranges from ⅙ to ¼ inches of the entire length of the side. This configuration allows the top or bottom of the back 140 to be easily flexed for insertion of the license plate.

The license plate is further held in place by the small tabs 170(a), (b), (c) and (d) on the right and left side. This triangle configuration allows the license plate to be easily slid into the plateguard 100 but inhibits the license plate from being removed from the plateguard 100. The plateguard 100 is then secured to the automobile via four or more screws which feed through the holes 160, 162, 164 and 166 in the license plate and through the back of the plateguard 100. This plateguard 100 is sturdy and rigid as a result of the material which extends from the top to the bottom of the plateguard forming a double diamond shape. The plateguard 100 also has the added feature of not being too heavy which would result if the entire back of the plateguard 100 was a solid substance which it is not.

The license plate is further held in place in the plateguard 100 by the small tabs 170(a), (b), (c) and (d) on the right and left and top and bottom sides. The small tabs can be placed at various distances from one another depending on the particular embodiment of the plateguard 100. When the plateguard 100 is manufactured from metal, the tabs can be bent in when the user pushes on them. In embodiments which are manufactured from a plastic type substance the tabs are formed in a triangle configuration. This triangle configuration allows the plate to be easily slid into the plateguard 100 but inhibits the license plate from being removed from the plateguard 100.

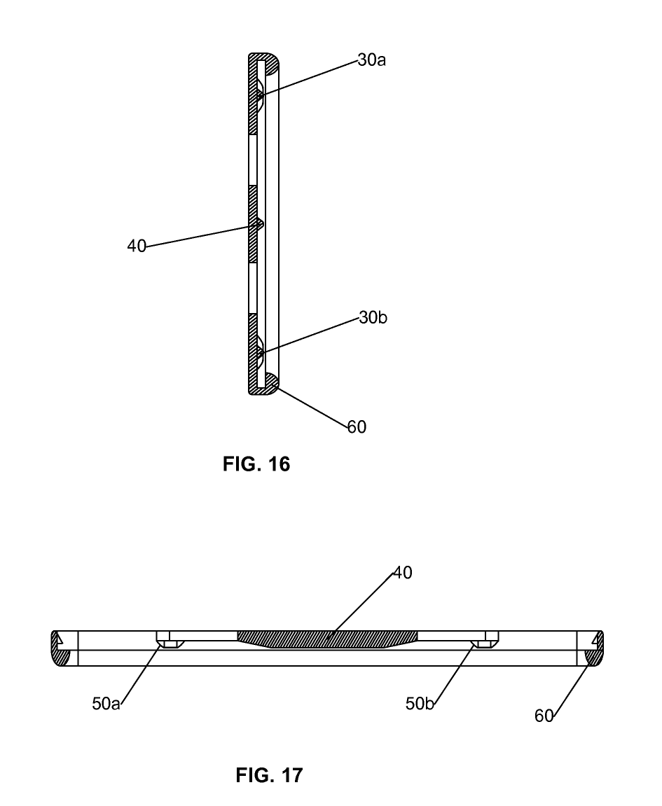

FIGS. 16 and 17 display cross sectional views of a plateguard with lifters. These cross sectional views are taken from embodiment 1 as shown in FIGS. 1 through 5. The lifters can be seen at 30a, 30b, 40, 50a, 50b, 50c, and 50d. The frontal face 60 appears in the cross sectional view. As was explained in earlier portions of the application, the lifters press against the license plate and hold it firmly to the frontal face and the face shield. This entire assembly is then attached to the automobile or truck. The lifters 30a, 30b, 40, 50a, 50b, 50c, and 50d are a key element to hold the license plate securely in place. These lifters allow any width of the license plate, flat or embossed, to be placed in the plateguard 100 and be held firmly and not rattle, or shake or vibrate.

In a few embodiments of the plateguard, the tabs which hold the license plate steady are manufactured with a notch configuration. This notch configuration is better suited to certain types of manufacture materials.

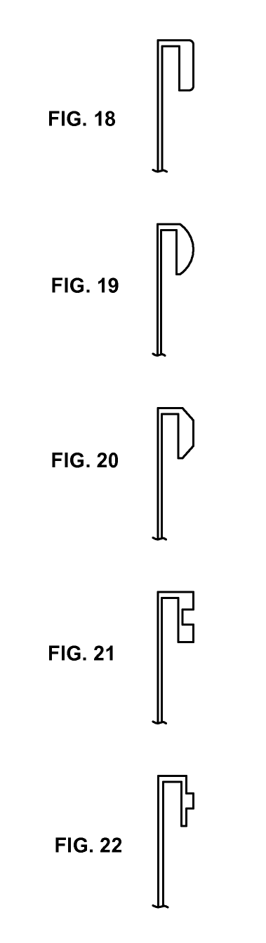

FIGS. 18 through 22 display the exterior dimensions of the plateguard frontal face this is shown in a cross sectional view. Every embodiment of the plateguard can have a different frontal faces. The frontal faces can be manufactured in various configurations such as square, rounded, half circle, diamond, channel or partially raised. These faces are displayed in FIGS. 18 through 22. FIG. 18 shows a square frontal face. This frontal face extends around the circumference of the front side of the plateguard. FIG. 19 displays a rounded frontal face. FIG. 20 displays a half-diamond shaped frontal face. FIG. 21 displays a double column frontal face. FIG. 22 displays a single column frontal face. Each of these frontal face configurations is thick enough to allow the plateguard to be sturdy and not flimsy. The frontal face of the plateguard can be modified and changed for aesthetic purposes.

The above description of disclosed embodiments is provided to enable any person skilled in the art to make or use the invention. Various modifications to the embodiments will be readily apparent to those skilled in the art, the generic principals defined herein can be applied to other embodiments without departing from spirit or scope of the invention. Thus, the invention is not intended to be limited to the embodiments shown herein but is to be accorded the widest scope consistent with the principals and novel features disclosed herein.

1. A license plate holder which secures a license plate to an automobile including:
a rigid and flexible back portion with at least two screw holes to secure the license plate holder to an automobile or truck,
a rigid and flexible front portion, attached to the back portion, which extends around the circumference of the license plate and covers at a maximum one half inch of the license plate,
one or more lifters which hold the license plate securely into the license plate holder,
a clear protecting shield covering the license plate, and
the front and the back portion being manufactured as a single unit to securely hold a license place with a space between the front portion and back portion into which a license place can be slid and held securely.

2. The license plate holder of claim 1, wherein the front and back portion are one continuous unit.

3. The license plate holder of claim 1, which is manufactured from one or more of the following materials: a polymer, a high impact polymer, ABS natural plateable grade plastic, ABS plastic, high impact polystyrene (HIPS or PS-I), styrene polymers, styrene, high resistant nylon, heat resistant nylon, sheet metal, aluminum, stainless steel, carbon fiber, flexible graphite, polyurethane, wood, flexible fiberglass, ethylene propylene diene monomer (E.P.D.M.), brass, and dye cast zinc and/or a variety of other substances.

4. The license plate holder of claim 1, wherein the back portion is manufactured in a double diamond shape.

5. The license plate holder of claim 1, which includes small bendable tabs which surround the back portion and can be bent into the license plate to hold it securely in the license plate holder.

6. The license plate holder of claim 1, wherein the back portion is configured in an H shape wherein the two arms of the H attach to the top and bottom of the license plate holder and the center piece connects the horizontal connector pieces to hold it rigid.

7. The license plate holder of claim 6, wherein the H contains four or more small extensions each with a screw hole passing through it.

8. The license plate holder of claim 1, wherein the license plate is slid into the holder from the top.

9. The license plate holder or claim 1, wherein the license plate is slid into the holder from the right or left side.

10. The license plate holder of claim 1, wherein the front portion has a face which can be configured in multiple shapes which may include various configurations such as square, rounded, half circle, diamond, channel or partially raised.

11. The license plate holder of claim 1, wherein there are no extensions or tabs on the front portion of the license plate holder.

12. A license plate holder to secure a license plate to an automobile or truck including:
a front and a back portion comprising a single unit connected together at their edges with a space between the two portions into which the license plate slides,
lifters on the interior side of the back portion to hold the license plate securely between the front and back portion,
the back portion including two or more screw holes to connect the license plate holder to an automobile or truck, and
the front portion including a frame which extends around the front face of the license plate and covers at a minimum ¼ inch of the circumference and at a maximum ½ inch of the circumference.

13. The license plate holder of claim 12, which is manufactured from one or more of the following materials: a polymer, a high impact polymer, ABS natural plateable grade plastic, ABS plastic, high impact polystyrene (HIPS or PS-I), styrene polymers, styrene, high resistant nylon, heat resistant nylon, sheet metal, aluminum, stainless steel, carbon fiber, flexible graphite, polyurethane, wood, flexible fiberglass, ethylene propylene diene monomer (E.P.D.M.), brass, and dye cast zinc and/or a variety of other substances.

14. The license plate holder of claim 12, which includes a clear protecting shield.

15. The license plate holder of claim 12, wherein the back portion is manufactured in a double diamond shape.

16. The license plate holder of claim 12, including small bendable tabs which surround the back portion and can be bent into the license plate to hold it securely in the license plate holder.

17. The license plate holder of claim 12, wherein the back portion is configured in an H shape wherein the two arms of the H attach to the top and bottom of the license plate holder and the center piece connects the horizontal connector pieces to hold it rigid.

18. The license plate holder of claim 16, wherein the H contains four or more small extensions each with a screw hole passing through it.

19. The license plate holder of claim 12, wherein the license plate is slid into the holder from the top.

20. The license plate holder or claim 12, wherein the license plate is slid into the holder from the right or left side.
